(19) United States
(12) Patent Application Publication
(10) Pub. No.: US 2004/0260862 A1
(43) Pub. Date: Dec. 23, 2004

(54) Adaptive migration planning and execution

(76) Inventor: Eric Anderson, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/600,601

(22) Filed: Jun. 20, 2003

(51) Int. Cl. G06F 12/00

(52) U.S. Cl. 711/100

(57) ABSTRACT

In an embodiment of the invention, a method for performing adaptive migration and execution, includes: obtaining a plan; adapting the plan to satisfy migration constraints; and starting at least one move of a data chunk in the initial plan.

### TECHNICAL FIELD

Embodiments of the present invention relate generally to migrating between storage system designs.

### BACKGROUND

In practice, modern computer systems are expected to be online continuously. Planned downtime for a computer system to accomplish system reconfiguration is becoming unacceptable. As a result, it is desirable to perform changes to computer systems that are online (e.g., computer systems that are running production workloads). One of these changes to computer systems is known as “data migration” which involves moving data within or among one or more storage devices for purposes of, for example, load balancing, system expansion, failure recovery, or other reasons. Traditional methods for achieving data migration may require application down-time, or may inefficiently perform the migration, resulting in an extended impact on the performance of the foreground applications.

Existing migration systems involve two phases: (1) migration planning, and (2) migration execution. During the planning phase, the planner estimates the time to perform a migration. However, during migration execution, the actual migration time for a given data unit (i.e., “chunk” or “data chunk”) might not be the same as the time predicted during migration planning, especially since the planning tends to use very simplistic metrics that do not, for example, account for various factors such as contention of resources. Furthermore, the actual migration time may be impossible to determine because of contention in the disk array, differences in the layout, and/or contention from other workloads. In current migration systems, the total migration time is typically increased beyond a time value that is acceptable in practice.

Therefore, the current technology is limited in its capabilities and suffers from at least the above constraints and deficiencies.

### SUMMARY OF EMBODIMENTS OF THE INVENTION

Embodiments of the present invention relate generally to migrating between storage system designs. In one embodiment of the invention, a method for performing adaptive migration and execution, includes: obtaining an initial plan; adapting the plan to satisfy migration constraints; starting at least one move of a data chunk in the initial plan; and determining if additional moves are required and obtaining a modified plan based upon the additional moves.

In another embodiment, a method for performing adaptive migration and execution, includes: obtaining an initial plan; determining all valid moves in the plan; starting a valid move; determining if additional moves are required and obtaining a modified plan after starting the valid move.

In another embodiment, a method for performing adaptive migration and execution, includes: obtaining a plan; adapting the plan to satisfy migration constraints; and starting at least one move of a data chunk in the initial plan.

In another embodiment, an apparatus for adaptive migration, includes: a planner configured to generate a migration plan based upon configuration information; an adapter configured to receive the plan from the planner, to receive migration constraints information, target configuration information and current configuration information, and to transmit configuration information to the planner; and at least one executor configured to execute a move in the plan.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of a data system in accordance with an embodiment of the invention, where migration of the data system from an example initial configuration to target configuration is shown.

FIG. 2 is a block diagram illustrating an apparatus for adaptive migration planning and execution, in accordance with an embodiment of the invention.

FIG. 3A is a flowchart illustrating a method for adaptive migration planning and execution, in accordance with an embodiment of the invention.

FIG. 3B is a flowchart illustrating a method for adaptive migration planning and execution, in accordance with another embodiment of the invention.

FIG. 4 is a flowchart illustrating various example options that are available for an adapter when selecting a move, in accordance with an embodiment of the invention.

FIGS. 5A to 5D are block diagrams illustrating examples of techniques for treating a data chunk as existing in both an old location and a new location.

FIG. 6 is a block diagram illustrating an apparatus for adaptive migration planning and execution, in accordance with another embodiment of the invention.

FIG. 7A is a flowchart illustrating a method for adaptive migration planning and execution, in accordance with another embodiment of the invention.

FIG. 7B is a flowchart illustrating a method for adaptive migration planning and execution, in accordance with another embodiment of the invention

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments the invention.

For purposes of the discussion herein, a “chunk” (or “data chunk”) is defined as a logical extent of data that can be moved. A data chunk can be, for example, a single disk block, a contiguous range of disk blocks, or a logical volume manager extent.

A disk array's storage is divided into logical units which are logically contiguous arrays of disk blocks that are exported by a disk array. Logical units are usually constructed by binding a subset of the array's disks together using RAID techniques. Logical unit sizes are typically fixed by the array configuration, and are thus unlikely to correspond to application requirements.

Logical volumes add flexibility by providing a level of virtualization that enables a server to split the logical units into multiple pieces or to stripe data across multiple logical units. A logical volume provides the abstraction of a virtual disk for use by a filesystem or database.

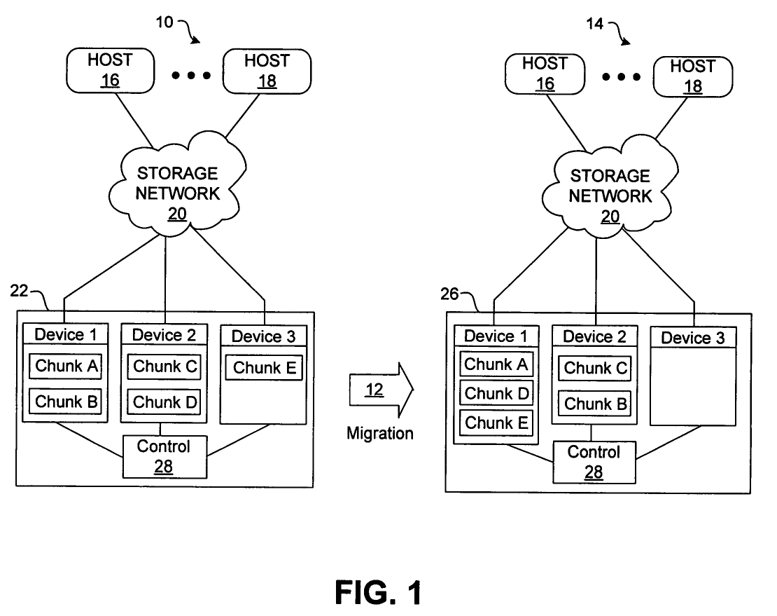

FIG. 1 is a block diagram of a data system in accordance with an embodiment of the invention, where migration of the data system from an example initial configuration 10 to an example target configuration 14 is shown. The initial configuration 10 and target configuration 14 includes a plurality of hosts 16 through 18 which are typically devices or systems such as computers, terminals, user devices, and/or the like, where the hosts may run different types of computer applications and may access different chunks of data. In an embodiment, the hosts 16 through 18 are connected to a storage network 20, which could be a local area network (LAN) or other types of suitable communication networks. The storage network 20 is, in turn, connected to the initial configuration 22 before performance of the migration 12. The storage network 20 will be connected to the target configuration 26 after performance of the migration 12. In one embodiment, the system 22 and system 26 may be the same system.

Typically, initial configuration data 22 and target configuration 26 include a plurality of data storage devices such as, for example, device 1, device 2, and device 3. The devices 1, 2, and 3 could be, for example, disks, disk drives, RAID (Redundant Array of Independent Disks) groups, disk arrays, tape drives, or other types of suitable data storage devices. The devices 1, 2, and 3 store chunks of data. The assignment of the data chunks A through E to the devices 1 through 3 is known as a “configuration”.

In the example of FIG. 1, in the initial configuration 22, the example initial configuration has chunk A and chunk B assigned to device 1, chunk C and chunk D assigned to device 2, and chunk E assigned to device 3. In contrast, in the target configuration 26, the example target configuration has chunk A, chunk D, and chunk E assigned to device 1, chunk C and chunk B assigned to device 2, and no data chunk assigned to device 3. The data chunks are moved among the storage devices 1, 2, and 3 under the direction of a control module 28 which can be, for example, a computer, processor, controller, or other types of processing device. It is noted that the control module 28 is typically implemented in a host that may run different types of computer applications and may access different chunks of data.

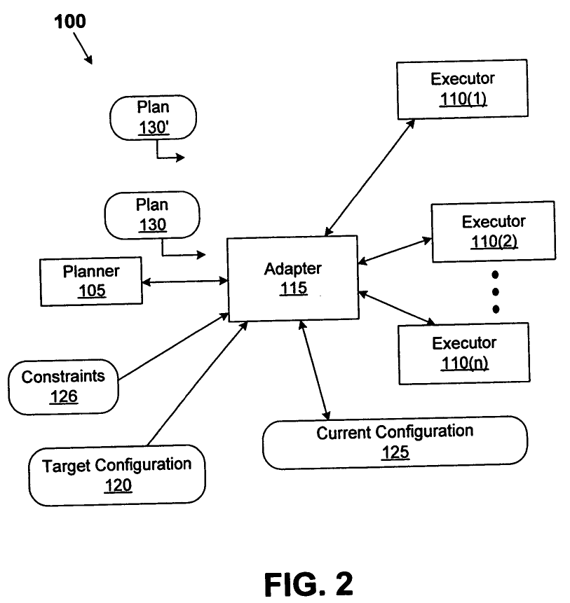

FIG. 2 is a block diagram illustrating an apparatus 100 for adaptive migration planning and execution, in accordance with an embodiment of the invention. The apparatus 100 is also referred herein as an adaptive migration engine 100. The apparatus 100 may be, for example, executed by (or integrated with) the control module 28 of FIG. 1 or may function with the control module 28 (and typically execute on a host). The elements of apparatus 100 may be implemented on one node or on a collection of nodes.

The apparatus 100 performs adaptive migration planning and execution as described below, in accordance with an embodiment of the invention.

The adaptive migration engine 100 takes as input the current configuration 125 of a data storage system and target configuration 120 for the data storage system, and changes the current configuration 125 to the target configuration 120. The adaptive migration engine 100 also takes migration constraints information 126 as input, where a migration constraint 126 may, for example, prevent one or more certain moves of data chunks from happening at the same time as other moves. The adaptive migration engine 100 configures the storage devices in the data storage system, moves the data chunks between old and new locations, and changes the parameters of the data storage system to match the parameters in the new configuration.

A planner 105 generates a migration plan 130 for the migration, and executors 110(1) to 110(n) execute moves and parameter changes in the plan, where n is a suitable integer value. The executors are also generally referred herein as executors 110. A migration plan 130 indicates, therefore, the moves of the data chunks from the old location to the new location when a migration is performed. Generally, the planner 105 tries to minimize the amount of scratch space that is used and the amount of data (e.g., data chunks) that needs to be moved.

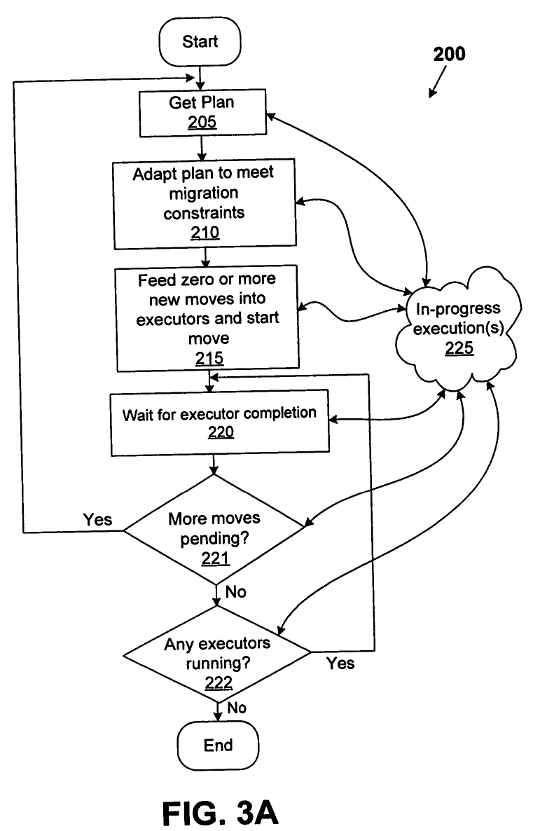

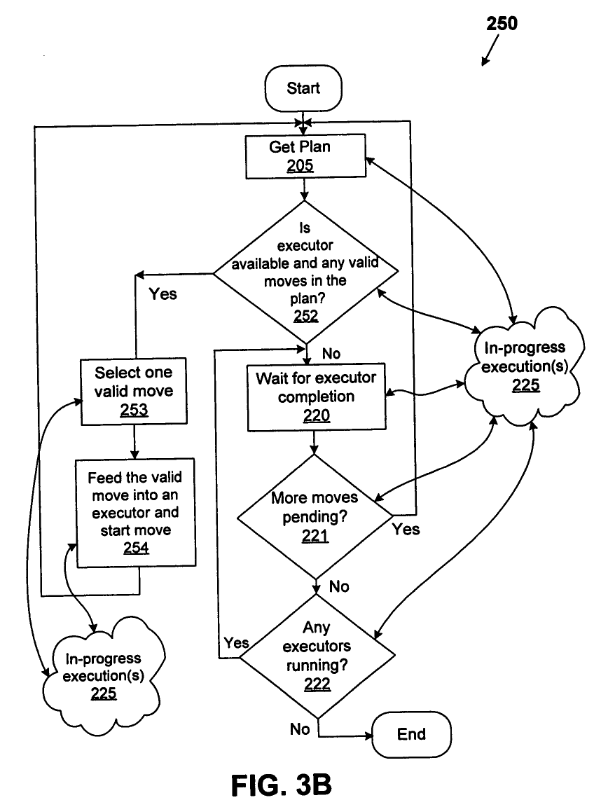

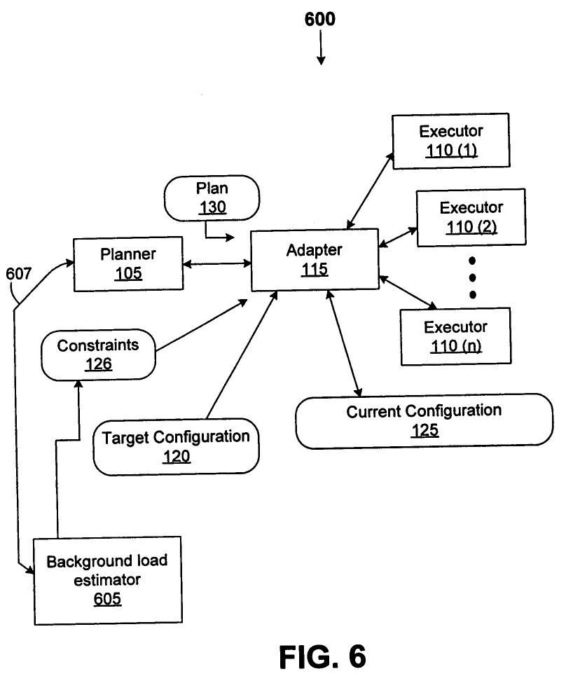

Generally, the executor 110 moves the data (e.g., data chunks) from their old locations to their new locations as specified by the plan 130. As described below, the adapter 115 feeds back configuration information to the planner 105 to permit the planner 105 to generate a new or modified plan 130′ that specifies alternate moves of data chunks from the old locations to the new locations. This feedback configuration information from the adapter 115 may include, for example, in-progress executions of moves (see block 225 in FIGS. 3A and 3B) and/or estimated application workload or background load (see block 635 in FIG. 6).

The planner 105 is typically implemented as code or firmware and is typically a conventional type of planner. Similarly, the executor 110 is typically implemented as code or firmware and is typically a conventional type of executor. The particular implementation of the planner 105 and executor 105 is typically dependent on the available operating system support, disk array support, and disk support for a data system that will perform migration planning and execution.

In an embodiment of the invention, the adapter 115 can provide various modes of operation which are described in the flowcharts that are described below. The adapter 115 can be implemented as code or firmware, in accordance with an embodiment of the invention.

It is noted that a conventional planner typically executes a migration planning algorithm which creates a series of migration steps with potentially multiple moves in a single step, where a “move” involves moving a data chunk from an old location to a new location. A conventional executor then typically takes the entire series of steps and executes each step in series.

In one embodiment of the invention, the adapter 115 obtains an initial plan 130 from the planner 105, and the moves in the initial plan 130 are selectively executed by the executor(s) 110 as described below. After one or more moves have been started (and/or completed) by an executor 110, the adapter 115 feeds back the changed data storage system configuration information into the planner 105. The planner 105 will then create a new or modified plan 130′ (FIG. 2) which is then fed into the adapter 115. The moves in the modified plan 130′ are then selectively executed by the executors(s) 110 as described below. The planner 105 will generate multiple modified plans 130′ in response to multiple feedbacks of changed data storage system configuration information from the adapter 115.

The adapter 115 receives target configuration information 120, which contains the parameters for a new configuration for the computer system (or data storage system). The adapter 115 also receives migration constraints 126. The executor(s) 110 will execute moves of the data chunks in order to achieve the target configuration 120, while typically satisfying the migration constraints 126. In an embodiment of the invention, the adapter 115 obtains an initial plan 130 and also tracks the current configuration information 125 of the computer system (or data storage system), and can track the current configuration 125 as it changes over a period of time during the migration process. The adapter 115 also feeds the current configuration 125 information to the planner 105 and also then obtains one or more modified plans 130′ from the planner 105.

Additional detail on the operation of the adaptive migration engine 100 is described with reference to the subsequent drawings.

FIG. 3A is a flowchart illustrating a method 200 for adaptive migration planning and execution, in accordance with an embodiment of the invention. The flowchart illustrates an option for handling moves (of data chunks) that are in progress when the planning algorithm (executed by the planner 105) is called.

An embodiment of the method 200 first modifies the input to the planner 105 in order to treat the data chunk(s) that are being moved, as if each chunk is currently located at both the source (old) location and destination (new) location. The modified input to the planner 105 generates a plan 130 in order to achieve the target configuration 120. The method 200 then post-processes the plan to conform to the rules (constraints) of the migration. An example of a migration rule is that each device is to be only involved in a single transfer at a time by excluding moves which use devices that are that are currently involved in a transfer. Another example of a migration rule is that each device can be the source of at most two moves and the destination of at most one move.

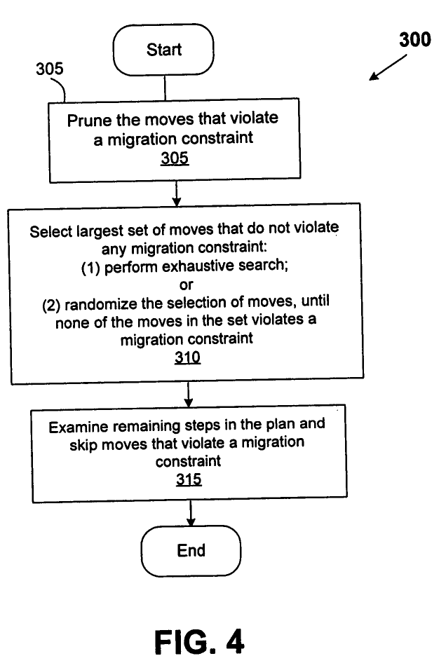

In step 205, the adapter 115 (FIG. 1) obtains plan 130 from the planner 105. In step 210, the adapter 115 adapts the plan 130 to meet migration constraints 126. The adapter 115 will determine in step 210 which particular moves to use, subject to the migration constraints 126. Some example options that are available for the adapter 115 when adapting the plan 130 and when selecting a move under step 210, are shown in FIG. 4.

After the plan 130 has been adapted in step 210, the adapter 115 will feed zero or more new moves into the appropriate executor(s) 110 that are not currently executing another move. The executor(s) 110 can then start at least one move of a data chunk in step 215. It is noted that after the plan 130 is adapted in step 210, the new moves that are to be subsequently performed can amount to zero or more new moves. As noted above, there could be a maximum of n executors 110, where n is a suitable integer value.

In step 220, the adapter 115 waits for an executor 110 to complete the execution of its move. The executors 110 that are executing in-progress moves are tracked in block 225 by adapter 115. In step 221, the adapter 115 determines if more moves need to be executed. If so, then the method 200 proceeds back to step 205 to obtain a new plan 130′ (FIG. 2) and steps 210 through 220 are repeated in a manner as described above.

In step 221, if there are no more moves that are pending, then the method 200 proceeds to step 222 which involves determining if any executors are still running (in-progress) and are thus processing a move(s). If any executors are still running, then the method 200 loops back to step 220, and the method 200 waits for executor completion and checks for additional pending moves in step 221. On the other hand, in step 222, if all executors have finished running, then the method 200 ends and the target configuration 120 will have been achieved by the adaptive migration engine 100.

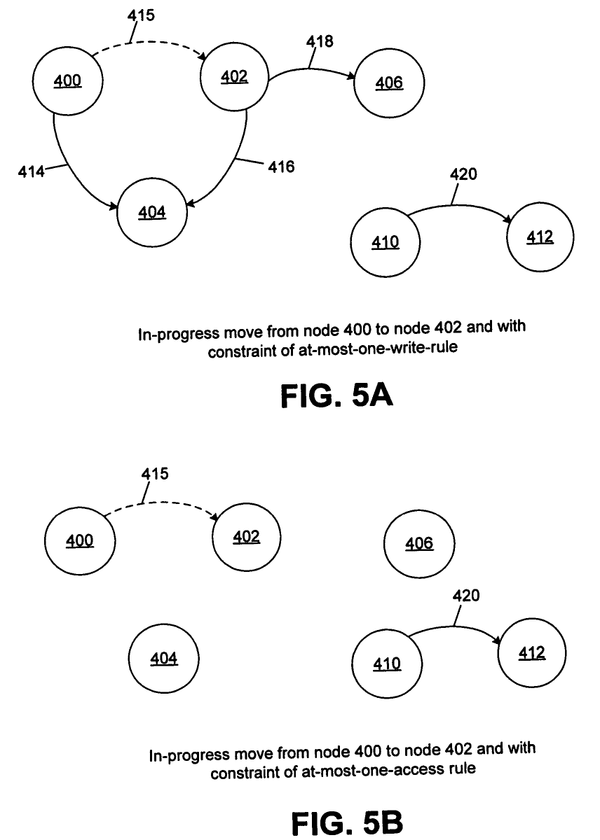

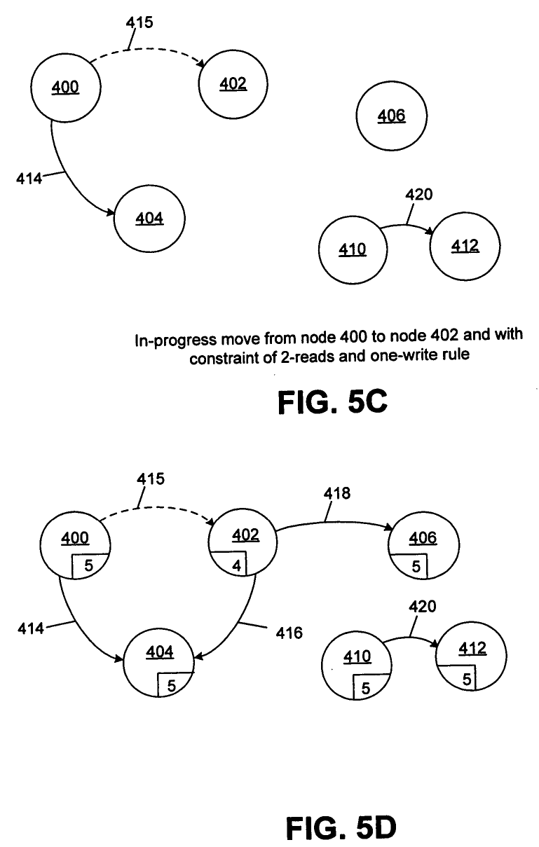

It is noted that when a modified plan 130′ is obtained in step 205 by the adapter 115, then the input graph (which is processed by the planner 105) may include moves that are in-progress, and the adapter 115 may treat the data chunks for such a move that is executing in-progress as existing at both the old location and new location. When a data chunk is currently being moved, the data chunk will actually use memory space (in a device) in the old location and new location. Various examples of techniques are described below with reference to FIG. 5 that can be used for treating a data chunk as existing in both an old location and a new location.

As noted above, when a modified plan 130′ is obtained in step 205, the data chunks for a plan that is executing in-progress is treated as existing at both the source location and destination location. An embodiment of the method 200 provides the “in-progress” moves 225 as a new input into the particular planning algorithm if the particular planning algorithm can record the in-progress moves 225. These in-progress moves 225 are examples of feedback information that are provided from the adapter 115 to the planner 105. Some planning algorithms can handle the moves that are in progress when planning. An example of planning algorithms are disclosed, for example, in Eric Anderson, et al., “Hippodrome: running circles storage administration” in Conference on File and Storage Technologies (FAST '02), pp. 175-188, 28-30 January 2002, Monterey, Calif., (USENIX, Berkeley, Calif.); and in Eric Anderson, et al., “An Experimental Study of Data Migration Algorithms”, in 5^{th} Workshop on Algorithm Engineering BRICS, University of Aarhus, Denmark, 28-30 August 2001 (WAE2001). Some planning algorithms can process the entire input graph. Examples of algorithms that can process the entire graph include the “2-factoring” algorithm and the “4-factoring” algorithm as disclosed in, for example, the above-noted reference “An Experimental Study of Data Migration Algorithms”, in 5^{th} Workshop on Algorithm Engineering BRICS, University of Aarhus, Denmark, 28-30 August 2001 (WAE2001).

FIG. 3B is a flowchart illustrating a method 250 for adaptive migration planning and execution, in accordance with another embodiment of the invention. It is noted that a method for adaptive migration planning and execution may be selected based upon the migration constraints and/or the capability of the planner 105. It is further noted that the steps in FIG. 3B, as similarly shown in FIG. 3A, are performed as described above. These steps include, for example, steps 205, 220, 221, and 222. An embodiment of the method 250 provides the in-progress moves 225 as a new input into the planning algorithm if the planning algorithm can handle the in-progress moves 225.

In method 250, after a plan 130 is obtained in step 205 by the adapter 115, the adapter 115 determines in step 252 if there is an executor available and if there are any valid moves in the plan 130. If there is no valid move in the plan 130 or no available executor, then the adapter 115 proceeds to steps 220 through 222 as similarly described above. On the other hand, if there are one or more valid moves in the plan 130 and an available executor, then the adapter 115 proceeds to steps 253 and 254. The adapter 115 selects one valid move in the plan 130 in step 253. The adapter 253 then feeds the valid move into an executor 110 and the executor 110 starts the valid move in step 254. The method 250 then loops back to step 205 to obtain a modified plan 130′, with the in-progress moves 225 as input into the planning algorithm of the planner 105. It is noted that when all moves have been started, then after a new plan 130′ is subsequently obtained in step 205, the method 250 will proceed to step 220 and to subsequent steps and will end after all executors are finished running in step 222. The target configuration 120 will have been achieved by the adaptive migration engine 100.

As described above, the method 250 obtains a new plan after each single valid move is started by an executor 110.

FIG. 4 is a flowchart 300 illustrating various example options that are available for an adapter 115 when selecting a move in step 210 in FIG. 3A, in accordance with an embodiment of the invention. It is noted that the adapter 115 does not necessarily select the options in the sequential manner of FIG. 4. For example, the adapter 115 may be programmed to give a higher priority to select one particular option over another particular option. Furthermore, some of the example options in FIG. 4 may be omitted or further modified.

As an option as shown in block 305, moves that violate a migration constraint can be pruned by the adapter 115 and are, therefore, not selected. Known methods for pruning a move may be used in block 305.

As another option as shown in block 310, the adapter 115 can select a largest set of moves that do not violate any migration constraint, where the set of moves will be executed by the executors. The set of moves can be determined in the following manner. For example, the adapter 115 can perform an exhaustive search of the moves in the plan to determine a largest set of moves that do not violate any migration constraint. Alternatively, the adapter 115 can perform a search to determine multiple sets of the same largest size. Alternatively, to increase the processing speed of the adapter 115, the adapter 115 can instead randomly pick moves in sequential order and include the picked moves in the set as long as the moves do not violate a migration constraint. Other techniques may be used in block 310 in order to obtain a largest set of moves that do not violate any migration constraints.

As another option as shown in block 315, the adapter 115 can examine the remaining steps in the plan and skip the moves that violate a migration constraint. The remaining steps in the plan may include at least some of the moves that are not yet executed or all of the moves that are not yet executed by the executors. The skipped moves are not selected to be executed.

FIGS. 5A to 5D are block diagrams illustrating examples of techniques for treating a data chunk as existing in both an old location and a new location, while a migration is in progress. It is noted that an in-progress move is shown as dashed arrows in the drawings. For example, the adapter 115 can track the moves of data chunks at nodes 400, 402, 404, 406, 410, and 412, where a node is defined as a memory space in a device (e.g., device 1, device 2, or device 3 in FIG. 1). A potential pending move of a data chunk from one node to another node is treated as an arc (e.g., arcs 414, 416, 418, and 420. The adapter 115 can track a move in progress and can feed this information to the planner 105 to permit the planner 105 to create a revised plan 130′. The iterative process of waiting for a move to complete, and then re-planning the migration continues until there are no more moves to execute. As a result of making the process iterative, the final plan will have adapted to the actual characteristics of the storage system.

In FIG. 5A, assume for example that there is an in-progress move 415 from node 400 to node 402 and that the constraint of at-most-one-write rule is applicable to the migration process. The at-most-one-write rule dictates that only one write operation can be performed to a node during a move. In the example of FIG. 5A, since there is an in-progress move 415 from node 400 to node 402, no other moves (arcs) will be permitted to node 402. The following moves are permitted: arc 414 from node 400 to node 404; arc 416 from node 402 to node 404; arc 418 from node 402 to node 406; and arc 420 from node 410 to node 412. Thus, when treating a data chunk as existing in the old location and new location while a move is in progress, moves that would violate an access rule would be pruned when a move is in progress.

In FIG. 5B, assume for example that there is an in-progress move 415 from node 400 to node 402 and that the constraint of at-most-one-access rule is applicable to the migration process. The at-most-one-access rule dictates that only one write operation (or alternatively, one read operation) can be performed to a node at one time. In the example of FIG. 5B, since there is an in-progress move 415 from node 400 to node 402, no operation to nodes 400 and 402 are permitted. The following move is permitted: arc 420 from node 410 to node 412.

In FIG. 5C, assume for example that there is an in-progress move 415 from node 400 to node 402 and that the constraint of two-reads and one-write rule is applicable to the migration process. The two-reads and one-write rule dictates that either two-read operations or one-write operation can be performed to a node at one time. In the example of FIG. 5C, since there is an in-progress move 415 from node 400 to node 402, no other read or write operation to node 402 is permitted. The following move is permitted: arc 414 which is a read operation from node 400 to node 404; and arc 420 from node 410 to node 412.

Some planning algorithms can consider the per-node free space information for a move to a node. In FIG. 5D, assume for example that there is an in-progress move 415 from node 400 to node 402 and that each node had free space for 5 data chunks (as indicated by the number 5 in the nodes 400, 404, 406, 410, and 412). As a result of the in-progress move 415 from node 400 to node 402, the free space for data chunks in node 402 will be four (4). As another example, if there is an in-progress move from node 400 to node 404, then the free space for data chunk in node 404 will also be 4 free spaces for data chunk. Thus, when treating a data chunk as existing in the old location and new location while a move is in progress, the data chunk is considered as decreasing a per-node free space information at both the old location and the new location when the move is in progress.

FIG. 6 is a block diagram illustrating an apparatus 600 for adaptive migration planning and execution, in accordance with another embodiment of the invention. The apparatus 600 includes components as similarly described for apparatus 100 in FIG. 2. In addition, the apparatus 500 includes a background load estimator 605 that can compute the background load on the storage system from the application. The background load estimator 605 may be, for example, a known host array instrumentation that detects the processor, disk, and application utilization. As another example, the background load estimator 605 may be an instrumentation that estimates the background load based upon interference. The instrumentation measures the delay amount during a move execution to determine the background load. For example, the access speed for a disk or array in a system is known, and the size of the data chunk is also known. If a move is known to require about 10 seconds to complete in a system, but the instrumentation measures about 20 seconds to actually complete the move, then there is a 100% application load. If the instrumentation measures about 15 seconds to actually complete the move, then there is a 50% application load. If the instrumentation measures about 30 seconds to actually complete the move, then there is a 200% application load.

In an embodiment of the invention, the background load estimator 605 communicates with (or is integrated with and is a function of) the planner 105, as symbolically shown by line 607. In a separate embodiment (also shown in FIG. 6 for convenience), the background load estimator 605 instead provides the background load information as constraints 126 to the adapter 115.

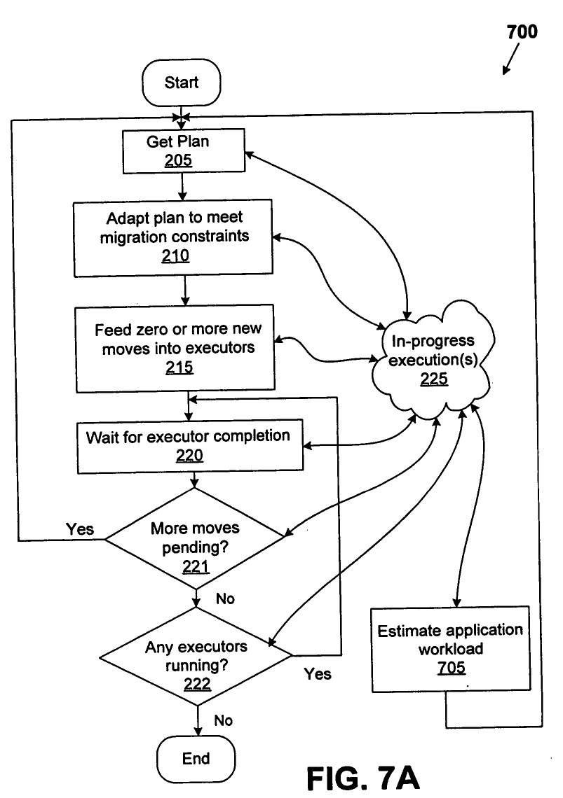

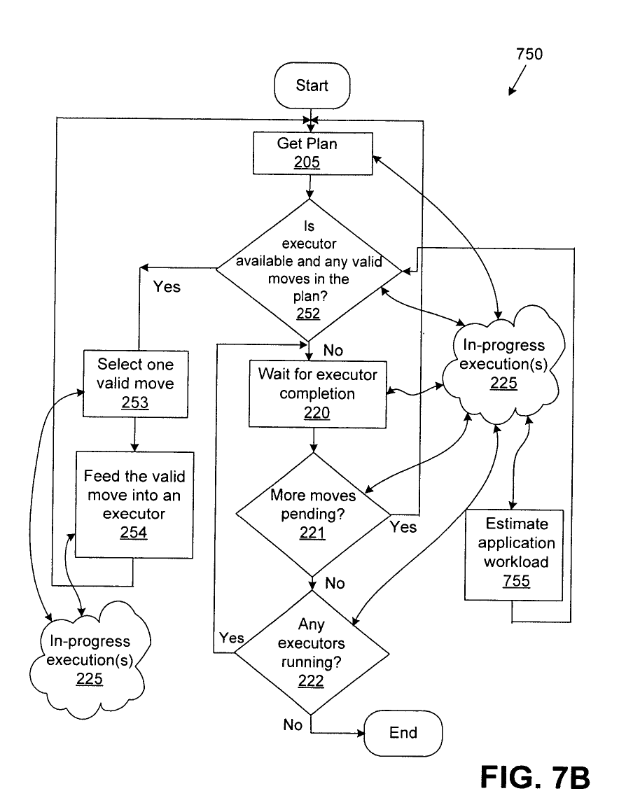

FIG. 7A is a flowchart illustrating a method for adaptive migration planning and execution, in accordance with another embodiment of the invention. It is further noted that the steps in FIG. 7A, as similarly shown in FIG. 3A, are performed as described above. The flowchart of FIG. 7A illustrates an option for handling background load information. In step 705, the application load information or background load information is estimated, and this estimated load information is then fed into the planner 105. This estimated load information is considered by the planner 105 when determining a modified plan 130′ in step 205 in FIG. 7A. As an example, the in-progress moves 225 can be treated as part of the background load. For example, if the original background load is about 25% and a migration move involving a write will add another 50% to the background load, then the background load will become 75% utilized, and this estimated load information is fed into the planner 105 prior to generating a modified plan 130′.

Some planning algorithms can attempt to take into account the background load on the storage system from the application. The background load computation can be performed in a manner as known to those skilled in the art. In contrast, some current systems, such as the AQUEDUCT migration executor, attempt to minimize the impact of migration on the foreground workload. The AQUEDUCT migration executor is described, for example, in: commonly-assigned U.S. patent application Ser. No. 09/843,882, entitled “METHOD AND SYSTEM FOR ONLINE DATA MIGRATION ON STORAGE SYSTEMS WITH PERFORMANCE GUARANTEES”, which is hereby fully incorporated herein by reference; and in Chenyang Lu, Guilllermo A. Alvarez, and John Wilkes, “Aqueduct: online data migration with performance guarantees”, in Conference on File and Storage Technologies (FAST '02), pp. 219-230, 28-30 January 2002, Monterey, Calif. (USENIX, Berkeley, Calif.).

FIG. 7B is a flowchart illustrating a method 750 for adaptive migration planning and execution, in accordance with another embodiment of the invention. It is further noted that the steps in FIG. 7B, as similarly shown in FIG. 3B, are performed as described above. In step 755, the application load information or background load information is estimated. In the method 750, it is assumed that the planner 105 does not have capability to consider the background load or application load when determining a modified plan 130′. Therefore, the estimated load information is treated as a migration constraint that is considered by the adapter 115 or as information for the adapter 115 to prioritize the moves, in step 252. The estimated load information is used by the adapter 115 in order to determine the valid moves in the plan in step 252. For example, a valid move may involve moving a data chunk from an overloaded device in the old location. As another example, an invalid move may involve moving a data chunk to an overloaded device in the new location. As another example, if a migration constraint dictates that minimal interference with the applications is required, then a valid move may involve moving a data chunk from an underloaded device in the old location.

The various engines discussed herein may be, for example, software, commands, data files, programs, code, modules, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or actions will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for performing adaptive migration and execution, the method comprising:
obtaining a plan;
adapting the plan to satisfy migration constraints; and
starting at least one move of a data chunk in the plan.

2. The method of claim 1, wherein the steps in the method are repeated until no moves are pending.

3. The method of claim 2, further comprising:
waiting for all in-progress executions of moves to complete after no moves are pending.

4. The method of claim 1, further comprising:
waiting for a move to complete if the adaptation of the plan indicates no moves meet the migration constraints.

5. The method of claim 1, further comprising:
estimating load value information; and
using the load value information to assist in determining a modified plan.

6. The method of claim 1, wherein adapting the plan comprises:
selecting at least one step from the following: pruning at least one move that violate a migration constraint; selecting a largest set of moves that do not violate a migration constraint; and skipping a move that violates a migration constraint.

7. The method of claim 1, further comprising:
treating a data chunk as existing in an old location and new location while a move is in progress.

8. The method of claim 7, wherein the step of treating the data chunk comprises:
pruning moves that violate an access rule when a move is in progress.

9. The method of claim 7, wherein the step of treating the data chunk comprises:
considering the data chunk as decreasing a per-node free space information at both the old location and the new location when a move is in progress.

10. A method for performing adaptive migration and execution, the method comprising:
obtaining a plan;
determining all valid moves in the plan;
starting a valid move; and
if additional moves are required, obtaining a modified plan after starting the valid move.

11. The method of claim 10, further comprising:
determining if an executor is available.

12. The method of claim 10, wherein the steps in the method are repeated until no moves are pending.

13. The method of claim 12, further comprising:
waiting for all in-progress execution of moves to complete after no moves are pending.

14. An article of manufacture, comprising:
a machine-readable medium having stored thereon instructions to:
obtain a plan;
adapt the plan to satisfy migration constraints; and
start at least one move of a data chunk in the plan.

15. An apparatus for adaptive migration, the apparatus comprising:
a planner configured to generate a migration plan based upon configuration information;
an adapter configured to receive the plan from the planner, to receive migration constraints information, target configuration information and current configuration information, and to transmit configuration information to the planner; and
at least one executor configured to execute a move in the plan.

16. The apparatus of 15, wherein the configuration information includes in-progress moves.

17. The apparatus of 15, wherein the configuration information includes load information.

18. The apparatus of 15, further comprising:
a load estimator configured to estimate load information for use in determination of the plan.

19. The apparatus of 18, wherein the configuration information includes load information.

20. The apparatus of claim 15, wherein the adapter obtains a plan until no moves are pending.

21. The apparatus of claim 20, wherein the adapter waits for all in-progress executions of moves to complete after no moves are pending.

22. The apparatus of claim 15, wherein the adapter waits for a move to complete if the adaptation of the plan indicates no moves meet the migration constraints.

23. The apparatus of claim 15, wherein the adapter estimates load value information and use the load value information to assist in determining an adapted plan.

24. The apparatus of claim 15, wherein the adapter is configured to select at least one step from the following: prune at least one move that violate a migration constraint; select a largest set of moves that do not violate a migration constraint; and skip a move that violates a migration constraint.

25. The apparatus of claim 15, wherein the adapter is configured to treat a data chunk as existing in an old location and new location while a move is in progress.

26. The apparatus of claim 25, wherein the data chunk is treated by pruning moves that violate an access rule when a move is in progress.

27. The apparatus of claim 25, wherein the data chunk is treated by considering the data chunk as decreasing a per-node free space information at both the old location and the new location when a move is in progress.

28. An apparatus for performing adaptive migration and execution, the apparatus comprising:
means for obtaining a plan;
means for adapting the plan to satisfy migration constraints; and
means for starting at least one move of a data chunk in the plan.
